(19) United States
(12) Patent Application Publication
(10) Pub. No.: US 2024/0388095 A1
(43) Pub. Date: Nov. 21, 2024

(54) SUPPORT OF AN ELECTRICAL POWER GRID

(71) Applicant: Telefonaktiebolaget LM Ericsson (publ), Stockholm (SE)

(72) Inventors: Lackis ELEFTHERIADIS, Valbo (SE); Athanasios KARAPANTELAKIS, Solna (SE); Konstantinos VANDIKAS, Solna (SE); Maxim TESLENKO, Sollentuna (SE); Karthik R M, Chennai (IN); Oleg GORBATOV, Luleå (SE); Gabriella NORDQUIST, Stockholm (SE)

(21) Appl. No.: 18/687,394

(22) PCT Filed: Aug. 30, 2021
(86) PCT No.: PCT/SE2021/050838

§ 371 Date: Feb. 28, 2024

(51) Int. Cl. H02J 3/28

(52) U.S. Cl. CPC H02J 3/28; H02J 2203/20

(57) ABSTRACT

A power supporting system includes a first power support handling unit and a first power support node, which node has a first bank of energy storage units and a first interface to the power grid with one separate connection per phase and which unit includes a processor acting on computer instructions whereby the unit is operative to obtain phase voltages of the power grid having been measured at least one measurement point and control the first power support node to support at least one of the phase voltages of the power grid based on an analysis of each of the phase voltages with regard to meeting a desired phase voltage level, which support involves using at least one energy storage unit of the first bank of energy storage units.

### TECHNICAL FIELD

The invention generally relates to the supporting of phase voltages of an electrical power grid. More particularly, the invention relates to a power supporting system for an electrical power grid as well as to a method, computer program and computer program product for of supporting an electrical power grid.

### BACKGROUND

In contemporary electrical power grids, there are limitations related to distributed capacity and volatility of the grid. Many utility operators are adding more renewable capacity to the grid, to be more sustainable, such as wind and solar capacity, but at the same time, as the sustainable power supplies are intermittent, the power supply from the grid gets more variable and dynamicity. Different techniques are currently used by grid operators to stabilize the grid, such as frequency regulation, active/reactive power control and voltage stabilization.

Current power grid operators are challenged by voltage balancing on different voltage phases. The voltage on the power grid may get lower and lower, as the power grid gets more loaded (for example if a mobile communication network is connected to the power grid and more users join the mobile communication network and produce higher volumes of uplink and downlink throughput). It is then possible that the voltage drop on the transmission lines of the power grid may reach unstable voltage levels. Also the environment around the access nodes, such as locations of enterprises may impact the power grid voltage.

In order to stabilize the voltage, the grid operator will then need to increase the voltage and to stabilize it, for instance by using a variable generator, including Automatic Voltage regulator, AVR. One way in which this can be done is through activating a Diesel Generator (DG) to support and keep the voltages stable, with or without AVR. DGs are expensive and also not environmentally friendly. Grid operators therefore need to enable new technology that is greener to support voltage stabilization.

Moreover, at the far end of the power grid to which a load, such as an access node of a mobile communication network, is connected there is currently a lack of generators to stabilize the voltage, close to the load.

There is thus a need for improvement in supporting the phase voltages of such a power grid.

### SUMMARY

One object of the invention is thus to provide support of the phase voltages of an electrical power grid, which electrical power grid may be a polyphase power grid.

This object is according to a first aspect achieved by a power supporting system for an electrical power grid. The power supporting system comprises a first power support handling unit and a first power support node, where the first power support node comprises a first bank of energy storage units and a first interface to the power grid, which interface has one separate connection per phase. The first power support handling unit in turn comprises a processor acting on computer instructions whereby the first power support handling unit is configured to:
obtain phase voltages of the power grid, which phase voltages have been measured at at least one measurement point, and
control the first power support node to support at least one of the phase voltages of the power grid based on an analysis of each of the phase voltages, where the analysis of a phase voltage is an analysis concerning meeting a desired phase voltage level and the support involves using at least one energy storage unit of the first bank of energy storage units.

The object is according to a second aspect achieved by a method of supporting an electrical power grid. The method is at least partly performed by a first power support handling unit of a power supporting system that comprises a first power support node having a first bank of energy storage units and a first interface to the power grid with one separate connection per phase. The method comprises:
obtaining phase voltages of the power grid, which phase voltages have been measured at at least one measurement point, and
controlling the first power support node to support at least one of the phase voltages of the power grid based on an analysis of each of the phase voltages, where the analysis of a phase voltage is an analysis concerning meeting a desired phase voltage level and the support involves using at least one energy storage unit of the first bank of energy storage units.

The object is according to a third aspect achieved by a computer program for supporting an electrical power grid from a power supporting system, which power supporting system comprises a first power support node having a first bank of energy storage units and a first interface to the power grid with one separate connection per phase. The computer program comprises computer program code which when run by a processor of a first power support handling unit of the power supporting system causes the first power support handling unit to implement the method steps of the second aspect.

The object is according to a fourth aspect achieved by a computer program product for supporting an electrical power grid from a power supporting system, which computer program product comprises a data carrier with the computer program code according to the third aspect.

The support may be a delivery of power to the power grid from the energy storage units or the reception of power from the power grid in the energy storage units. For this reason, the first interface to the power grid may also be considered to be a bidirectional interface.

At least one measurement point may be provided at the first interface to the power grid. At this first interface there may more particularly be a measurement point at each of the connections to the power grid.

The first power support node may comprise at least one load to be supplied by power from the power grid and the first bank of energy storage units may comprise at least one energy storage unit for supplying reserve or backup power to the load when the power grid is down at the corresponding interface to the power grid.

The first power support node may additionally comprise a power distribution network connected between the power grid interface and the at least one load. The first bank of energy storage units may additionally be connected to the power distribution network via a distribution network interface comprising one or more converters.

According to one variation of the first aspect the first power support handling unit is configured to analyse each of the phase voltages with regard to meeting a desired phase voltage level.

In a corresponding variation of the second aspect the method further comprises analysing each of the phase voltages with regard to meeting a desired phase voltage level.

This analysis may involve performing a comparison of each of the phase voltages with a voltage threshold, where if the voltage falls below or rises above the desired phase voltage level and reaches the voltage threshold, the corresponding phase is deemed to need support.

It is additionally possible that the control is performed also based on a request for voltage support from the power grid. The controlling may thus be triggered by the request.

In yet another variation of the first aspect, the first power support handling unit receives the request for voltage support.

In a corresponding variation of the second aspect, the method further comprises receiving the request for voltage support.

The request may comprise the desired phase voltage level. It may additionally comprise a time window in the future in which the power grid needs support. The request may additionally originate in a control system for the power grid, such as a supervisory control and data acquisition (SCADA) system.

The control or controlling the first power support node to support at least one of the phase voltages, may be a control or controlling of the first power support node to support the at least one of the phase voltages of the power grid with support power corresponding to at least a part of the power that the power grid needs assistance with for meeting the corresponding desired phase voltage level.

According to a further variation of the first aspect, the first power support handling unit is configured to determine the power with which the power grid needs assistance.

According to a corresponding variation of the second aspect, the method further comprises determining the power with which the power grid needs assistance.

The control or controlling of the first power support node to support at least one of the phase voltages, may comprise control or controlling the first power support node to support the at least one of the phase voltages of the power grid with support power during a support time interval for providing support energy at least partly making up energy that the power grid needs assistance with, which needed energy is based on a determination of a length of time during which the power grid needs assistance with the needed power.

It is additionally possible that the controlling is made in more than one support time interval.

According to another variation of the first aspect, the first power support handling unit is further configured to determine the length of time during which the power grid needs assistance with the needed power for obtaining the needed energy and to determine the support energy making up at least a part of the needed energy.

According to a corresponding variation of the second aspect, the method further comprises determining the length of time during which the power grid needs assistance with the needed power for obtaining the needed energy and determining the support energy making up at least a part of the needed energy.

The control or controlling of the first power support node to support at least one of the phase voltages of the power grid may additionally be based on an investigation of condition information of the energy storage units of the first power support node.

Here it is additionally possible that the condition information comprises information about available energy in the energy storage units.

It is in this case additionally possible that the first power support handling unit is configured to investigate the condition information of the energy storage units of the first power support node. It is also possible that the method comprises investigating the condition information of the energy storage units of the first power support node.

It is furthermore possible that the phase voltages and condition information are part of a state in a state space and the support power is a part of a power support action in an action space of a voltage supporting model, where in the model power support actions and results of power support actions are stored together with rewards for the power support actions calculated using a reward function, where according to the model a current state on which a current power support action is to be used is the result of a previous power support action.

In this case the control or controlling of the first power support node may comprise control or controlling the first power support node, after the power supporting model has been trained, using support power that is part of an action in the action space of the model that optimizes the reward.

It is additionally possible that the power support handling unit is configured to calculate a reward for a current power support action based on the result of the power support action and to store the current power support action, the result of the current power support action and a current state for the voltage support model in an experience memory.

It is in this case possible that the method further comprises calculating a reward for a current power support action based on the result of the power support action and to store the current power support action, the result of the current power support action and a current state for the voltage support model in an experience memory.

It is furthermore possible that the power support handling unit is further configured to train the voltage support model. The method may also comprise training the voltage support model.

It is additionally possible that the reward function has weights, and these weights may be pretrained.

It is furthermore possible that the power supporting system comprises a group of power support nodes including the first power support node, which nodes are placed at different locations and where each power support node comprises an interface to the power grid with one connection per phase, a bank of energy storage units and a power support handling unit. In this case the power support handling unit of at least one other power support node supports the at least one of the phase voltages of the power grid based on the analysis using at least one energy storage unit of the bank of energy storage units of this other power support node.

As was described earlier, at least one measurement point may be provided at the first interface to the power grid. When there are other power support nodes, each may have at least one measurement point at the interface to the power grid. At such an interface there may more particularly be a measurement point at each of the connections to the power grid.

All phase voltages may be supported by all power support nodes. As an alternative it is possible that a certain phase is supported by the first power support node and at least one other power support node.

In a variation of the first aspect, the first power support handling unit, when being configured to control the first power support node to support a phase voltage of the power grid, is configured to control the first power support node with a first amount of support power and the power support handling unit of the other power support node is configured to support the phase voltage of the power grid with another amount of support power.

In a corresponding variation of the second aspect, the controlling of the first power support node to support a phase voltage of the power grid comprises controlling the first power support node with a first amount of support power and where the power support handling unit of the at least one other power support node controls the other power support node to support the phase voltage with another amount of support power.

There may furthermore exist signal connections between the power support nodes.

In this case the first power support handling unit may be configured to exchange information with the power support handling units of the other power support nodes concerning obtained phase voltages and condition information of energy storage units as well as to negotiate assistance in the support of the at least one phase via the signal connections.

In this case the method may further comprise exchanging information with the power support handling units of the other power support nodes concerning obtained phase voltages and condition information of energy storage units and negotiating assistance in the support of the at least one phase voltage from the power support handling units of the other power support nodes via the signal connections.

The analysis of each of the phase voltages with regard to meeting a desired phase voltage level and the investigation of condition information of energy storage units may be performed in a power support distribution control unit, where additionally the investigation of condition information may be an investigation of condition information of the energy storage units of all the power support nodes.

When there is a power support distribution control unit, it may additionally receive the request for voltage support.

In this case the first power support handling unit may be configured to control the first power support node to support the at least one of the phase voltages of the power grid and the power support handling unit of the at least one other power support node may be configured to control the at least one other power support node to support the at least one of the phase voltages of the power grid based on a power support distribution determination made by the power distribution control unit.

In this case the controlling of the first power support node to support the at least one of the phase voltages of the power grid performed in the method and the control of the at least one other power support node to support the at least one of the phase voltages of the power grid may be based on a power support distribution determination made by the power distribution control unit.

According to another variation of the first aspect, the first power support handling unit is configured to control the first power support node to support the at least one of the phase voltages of the power grid and the power support handling unit of the at least one other power support node is configured to control the at least one other power support node to support the at least one of the phase voltages of the power grid based on a selection of power support nodes for supporting the phase voltage that has been made by the power support distribution control unit based on the determined needed power as well as based on investigated condition information of the energy storage units of each of the power support nodes.

According to a corresponding variation of the second aspect, the controlling of the first power support node to support the at least one of the phase voltages of the power grid and the control of the at least one other power support node to support the at least one of the phase voltages of the power grid is based on a selection of power support nodes for supporting the phase voltage having been made by the power support distribution control unit based on the determined power as well as on the investigation of condition information of the energy storage units of each of the power support nodes.

It is furthermore possible that the power supporting system comprises the power support distribution control unit, where it may be a part of the first power support node or related, such as another node in the power supporting system.

In this case the power support distribution control unit may be configured to select power support nodes for supporting the phase voltage based on the determined needed power as well as based on investigated condition information of the energy storage units of each of the power support nodes.

In this case the method may further comprise selecting, in the power support distribution control unit, power support nodes for supporting the phase voltage based on the determined needed power as well as based on investigated condition information of the energy storage units of each of the power support nodes.

In this case it is furthermore possible that the selection of power support nodes is based on the distances between the power support nodes and the shape of the phase voltages at their interfaces to the power grid.

The power support nodes of the power supporting system may be access nodes of a mobile communication network, for instance base stations.

The invention according to the above-mentioned aspects has a number of advantages. It provides support of the phase voltages without the needed for the use of generators. Furthermore, energy storage units are often provided for use as backup power in the power supporting system. When this is the case they may be put to more efficient use.

It should be emphasized that the term “comprises/comprising” when used in this specification is taken to specify the presence of stated features, integers, steps or components, but does not preclude the presence or addition of one or more other features, integers, steps, components or groups thereof.

### BRIEF DESCRIPTION OF THE DRAWINGS

The invention will now be described in more detail in relation to the enclosed drawings, in which:

FIG. 1 schematically shows a first realization of a power supporting system comprising a first power support node connected to three phases of an electrical power grid, where the first power support node is realized as an access node of a mobile communication network,

FIG. 2 schematically shows a first realization of a first power support handling unit of the first power support node,

FIG. 3 schematically shows a second realization of the first power support handling unit,

FIG. 4 schematically shows a number of method steps in a first embodiment of a method of supporting the electrical power grid, which steps are performed by the first power support handling unit,

FIG. 5 schematically shows a number of method steps in a second embodiment of the method of supporting the electrical power grid, which steps are performed by the first power support handling unit,

FIG. 6 schematically shows phase voltages of the electrical power grid, where a first phase voltage needs to be balanced,

FIG. 7 schematically shows support energy supplied to the three phases during a time window for balancing the first phase,

FIG. 8 schematically shows a second realization of the power supporting system comprising a number of power support nodes including the first power support node,

FIG. 9 schematically shows a number of method steps in a third embodiment of a method of supporting the electrical power grid, which steps are performed by the first power support handling unit,

FIG. 10 shows voltages of a first phase at the different power support nodes, where a phase voltage of a first phase at the first power support node needs to be balanced, as well as support energy supplied to the first phase from the different power support nodes,

FIG. 11 schematically shows a third realization of the power supporting system comprising the first and a second power support node communicating with a central power support distribution control unit,

FIG. 12 schematically shows a number of method steps being performed by the power support distribution control unit,

FIG. 13 shows a number of machine learning method steps used for populating a state space and an action space in a voltage support model,

FIG. 14 shows a number of method steps for supporting the electric power grid based on the voltage support model, and

FIG. 15 schematically shows a computer program product comprising a data carrier with computer program code for realizing the first power support handling unit.

### DETAILED DESCRIPTION

In the following description, for purposes of explanation and not limitation, specific details are set forth such as particular architectures, interfaces, techniques, etc. in order to provide a thorough understanding of embodiments of the invention. However, it will be apparent to those skilled in the art that the invention may be practiced in other embodiments that depart from these specific details. In other instances, detailed descriptions of well-known devices, circuits and methods are omitted so as not to obscure the description of the invention with unnecessary detail.

Aspects of the present disclosure are directed towards supporting the phase voltages of an electrical power grid, which supporting is being made via a power supporting system connected to the electrical power grid.

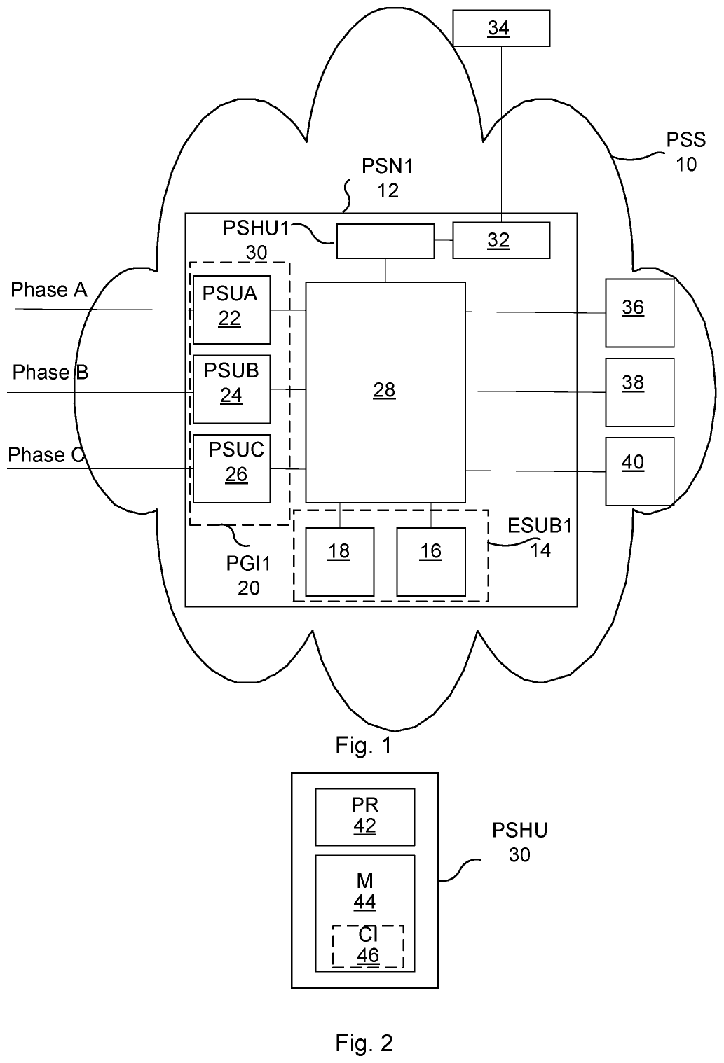

FIG. 1 shows a power supporting system PSS 10 comprising a first power support node 12. In its simplest form the power supporting system 10 comprises only this first power support node 12. However, as can be seen later it is possible with more power support nodes in the power supporting system 10.

The first power support node 12 comprises a first power grid interface PGI1 20 that is connected to the electrical power grid. The power grid is a three-phase power grid that therefore comprises a first phase A, a second phase B and a third phase C. The first power grid interface 20 comprises one separate connection per phase. It thus has a first connection to the first phase A, a second connection to the second phase B and a third connection to the third phase C. The first power grid interface 20 also comprises at least one bidirectional power supply unit, and in this case it comprises three separate bi-directional power supply units. There is a first bidirectional power supply unit PSUA 22, a second bidirectional power supply unit PSUB 24 and a third bidirectional power supply unit PSUC 26, where the first power supply unit 22 has a grid side connected to the first phase A, the second power supply unit 24 has a grid side connected to the second phase B and the third power supply unit 26 has a grid side connected the third phase C. The first power grid interface 20 may additionally comprise sensors for measuring each of the phase voltages and optionally also for measuring each of the phase currents. For this reason, the first power support node 12 may additionally have at least one measurement point at the power grid interface 20. It may more particularly have a measurement point at each of the connections to the power grid.

The first power support node 12 also comprises at least one load, where in the example in FIG. 1 it comprises three loads. There is a first load 36, a second load 38 and a third load 40. These loads are typically fed with power from the power grid. Because of this the loads are connected to the power grid via a local power distribution network 28, where the power distribution network 28 a direct current (DC) network. There may additionally be sensors at these loads 36, 38 and 40.

There is furthermore a first bank of energy storage units or first energy storage unit bank ESUB1 14 in the first power support node 12, which first bank of energy storage units 14 comprises at least one energy storage unit and in the present case there are two energy storage units. There is here a first energy storage unit 16 and a second energy storage unit 18, which may both be batteries. The first energy storage unit may additionally be a Li-ion battery and the second energy storage unit may be a valve regulated lead-acid (VRLA) battery. The first bank of energy storage units may be connected to the power distribution network 28 via a distribution network interface comprising one or more converters, which converters may be DC-DC converters.

As mentioned above, the power supply units 22, 24 and 26 have a grid side connected to the power grid. They also have a network side connected to the power distribution network 28. When the power distribution network 28 is a DC network, the power supply units 22, 24 and 26 may be realized as voltage source converters, such as two-level voltage source converters or modular multilevel converters (MMCs).

There is also a first power support handling unit PSHU1 30, which first power support handling unit 30 supports the phase voltages of the power grid. For this reason, it may control transmission of power through the power distribution network 28 for performing such support. It may more particularly control the power supply units 22, 24 and 26 of the first power grid interface 20 as well as possibly also the converters in the distribution network interface. It should also be realized that the batteries may be equipped with sensors, such as sensors for sensing battery charge. The first power support handling unit 30 may also receive data from these sensors. The first power support handling unit 30 may additionally receive data from voltage sensors and current sensors in the first power grid interface 20, but also sensor information from the loads 36, 38 and 40.

The first power support node 12 may be an access node of a mobile communication network, such as a fourth- or a fifth-generation mobile communication network, and may because of this be a base station in such a mobile communication network. In this case the loads 36, 38 and 40 are realized as radio circuits and antennas for radio communication.

Finally, the power support handling unit 12 is shown as being connected to a processing unit 34 via a communication interface 32. The processing unit 34 may be provided in an operations support system (OSS) for the mobile communication system. It may as an example be provided in a network manager function of such an OSS system. In this case the communication interface 32 may be an interface to a backhaul network used for communication with the OSS. The processing unit 34 may additionally or instead be implemented in the cloud and therefore the communication interface 32 may in this case be a cloud communication interface.

The processing unit 34 may perform some processing for the first power support handling unit 30, which processing may thus be performed in the cloud. However, it is also possible that the processing for the first power support handling unit 12 is in its entirety performed in the first power support handling unit 30, in which case the communication interface 32 and processing unit 34 may be omitted.

FIG. 2 schematically shows a first realization of the first power support handling unit 30. The first power support handling unit 30 may be provided in the form of a processor PR 42 connected to a program memory M 44. The program memory 44 may comprise a number of computer instructions 46 implementing the functionality of the first power support handling unit 30.

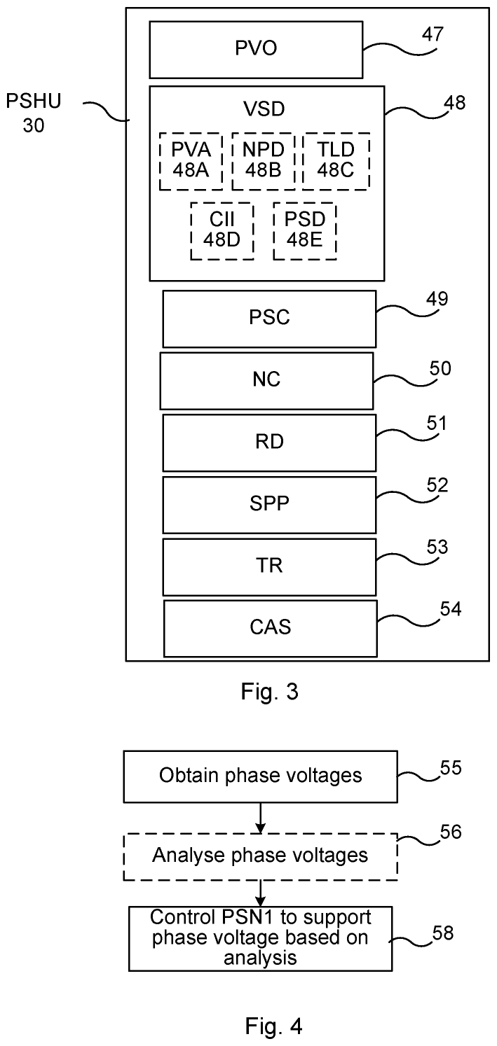

FIG. 3 shows a second realization of the first power support handling unit comprising a number of blocks. It comprises a phase voltage obtaining block PVO 47, a voltage support determining block VSD 48, a power support coordinating block PSC 49, a node controller block NC 50, a reward determining block RD 51, a state space populating block SP 52, a training block TR 53 and a control action selection block CAS 54. The voltage support determining block 48 furthermore comprises a phase voltage analysing element PVA 48A, a needed power determining element NPD 48B, a time length determining element TLD 48C, a condition information investigating element CII 48D and a power support determining element PSD 48E. Here the reward determining block 51, the state space populating block 52, the training block 53 and the control action selection block 54 are employed when machine learning is used. In embodiments where machine learning is not used these blocks may therefore be omitted.

The blocks in FIG. 3 may be provided as software blocks, for instance as software blocks in a program memory, or as hardware blocks, such as through one or more application-specific integrated circuits (ASICs) or field-programmable gate arrays (FPGAs).

Furthermore, depending on the amount of functionality provided in the first power support determining unit 30, the power support coordinating block 49 and one or more of the elements in the voltage support determining block 48 may additionally be omitted, where it is in fact possible that the whole voltage support determining block 48 is omitted.

In this simplest form, the first power support handling unt 30 only comprises the phase voltage obtaining block 47 and the node controller block 50, where the phase voltage obtaining block 47 supplies phase voltages detected at the first power grid interface 20 to the processing unit 34, which in turn sends an instruction to support at least one of the phases to the node controller block 50 of the first power support handling unit 30.

Due to the introduction of new power sources such as solar and wind power sources, a power grid is today often unstable and volatile and may need to be supported.

At the same time many systems are equipped with redundant energy storage units, such as batteries, for emergency situations when power is down. It is for instance possible that a mobile communication system has batteries in order to guarantee continued operation when the power grid is unable to deliver power. Also other types of systems may have such spare capacity, such as data centres.

These energy storage units that are provided for reserve power are in many cases very infrequently used. It is therefore of interest to use the energy storage units of a power supporting system to support the power grid. Aspects described herein are directed toward supporting one or more of the phase voltages of the power grid.

A first embodiment will now be described with reference being made to FIG. 4, which shows method steps in a method of supporting the electrical power grid, where the method steps are being performed in the first power support handling unit 30. Steps that are always performed in the node 12 are shown with solid boxes, while a step that can be performed in the processing unit 34 is shown in a dashed box.

In this case the first power support handling unit 30 comprises the phase voltage obtaining block 47 and the node controller block 50. If no processing in the cloud is made, it also comprises one or more of the elements in the voltage support determining block 48. In this case it may at least comprise the phase voltage analysing element 48A and the needed power determining element 48B, while the time length determining element 48C, the condition information investigating element 48D, the power support coordinating block 49 and the machine learning related blocks 51, 52, 53 and 54 may be omitted.

Moreover, if the cloud processing unit 34 is used, then this could perform one or more of the operations of the voltage support determining block 48, which means this block may be partly or in its entirety omitted from the first power support handling unit 30.

The method may be started by the phase voltage obtaining block 47 obtaining phase voltages of the power grid having been measured at at least one measurement point, step 55, where in the case of the first realization of the power supporting system 10, all the measurement points are at the connections of the first power grid interface 20 to the power grid. It is for instance possible that there is one measurement point per phase. The obtaining of the phase voltages may be done through the phase voltage obtaining block 47 receiving or fetching such phase voltage measurements from voltage sensors of the first power grid interface 20. These measurements are then forwarded to the voltage support determining block 48, which as was mentioned earlier may be provided in the first power support handling unit 30 or in the processing unit 34. The phase voltage analysing element 48A of the voltage support determining block 48 then analyses each of the phase voltages with regard to meeting a desired phase voltage level, step 56, where the desired phase voltage is a reference voltage.

A phase voltage may have a nominal level that it should occupy such as 230 VAC and the analysis may therefore involve investigating if a phase voltage differs from this level. It is additionally possible that the power with which the power grid needs assistance is determined, which may thus be the power required for reaching the reference voltage. The power may be determined by the needed power determining element 48B based on the measured phase current of the phase and a difference between the reference voltage and the measured voltage. It is additionally possible that it is the amplitude of the phase voltage that is compared with the reference voltage. It is also possible that the phase current is estimated based on current or power delivered to the loads 36, 38 and 40. The needed power may then be considered by the power support determining element 48E to be power needed for assisting the power grid to reach the desired phase voltage, where the needed power may be supplied to the power grid in case the phase voltage has fallen below the reference voltage or a receiving of the needed power from the power grid in case the phase voltage has exceeded the reference voltage.

The power support determining element 48E may then be notified and thereafter send an instruction to the node controller block 50 to support the phase voltage, which may be an instruction to support the phase voltage with support power corresponding to the needed power, which may thus be a supplying of the support power to the grid or a reception of the support power from the grid. Alternatively, the instruction may be sent directly from the needed power determining element 48B, in which case the power support determining element 48E may not be needed. It is here possible that the support power makes up the whole of the needed power. It may also be made up of a part of the needed power. The support power thus makes up at least a part of the needed power.

The instruction thus triggers the node controller block 50 of the first power support node to support the phase voltage. Thereby the node controller block 50 controls the first power support node 12 to support at least one of the phase voltages of the power grid of each of the phase voltages with regard to meeting a desired phase voltage level based on the analysis performed by the phase voltage analysing element 48A of the voltage support determining block 48, step 58. The support may more particularly involve using at least one of the energy storage units 16 and 18 of the first bank of energy storage units 14.

The node controller block 50 may more particularly control the first power support node 12 to support at least one of the phase voltages of the power grid with support power corresponding to at least a part of the power that the power grid needs assistance with for meeting the corresponding desired phase voltage level. It may thus control the first power support node to provide support with all the needed power or with parts of the needed power. In order to do this, the node controller block 50 may control the converters of the distribution network interface to make one or more energy storage units of the first bank of energy storage units 14 to supply or receive the support power to or from the power distribution network 28. It may also control one or more of the power support units 22, 24 and 26 to supply or receive the support power to or from the power grid. If for instance the first phase A needs support, then the first power supply unit 22 may be controlled to supply or receive all the support power. As an alternative it is possible that the first power supply unit 22 is controlled together with one or more of the other power supply units 26 and 28 to supply or receive the supply power needed for stabilizing the phase voltage.

In this way voltage support can be performed via the first power support interface 20. Furthermore, one purpose of the first bank of energy storage units 14 may be to provide backup power for the loads 36, 38 and 40. As the bank 14 is now also used for supporting the power grid, the energy storage elements 16 and 18 are also used more efficiently.

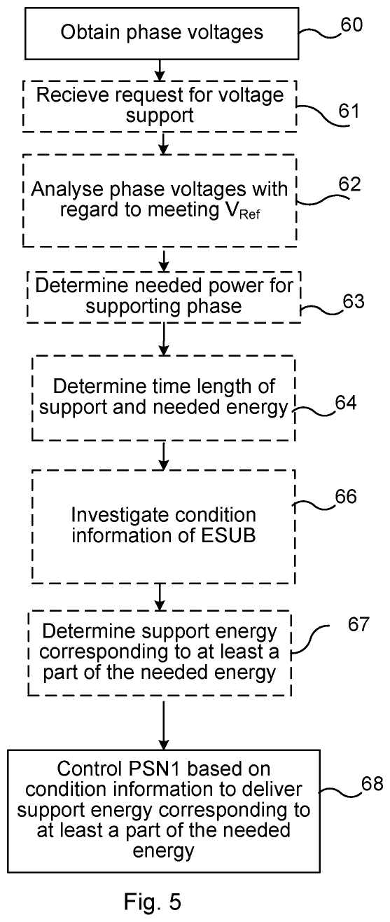

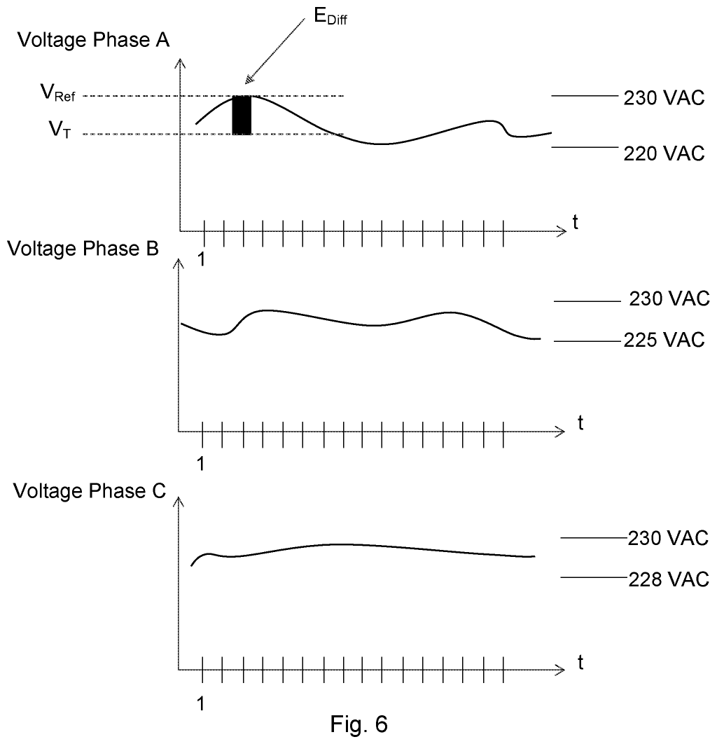

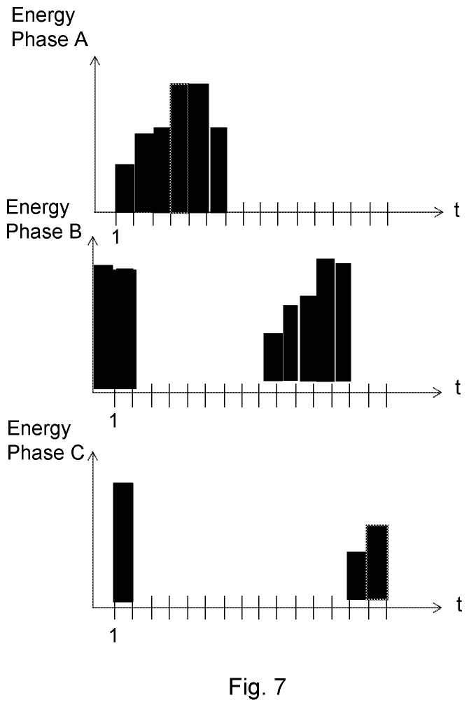

Now a second embodiment will be described with reference being made to FIGS. 5, 6 and 7, where FIG. 5 schematically shows a number of method steps in a second embodiment of the method of supporting the electrical power grid, which steps are performed by the first power support handling unit, FIG. 6 schematically shows phase voltages of the electrical power grid, where a first phase voltage needs to be balanced and FIG. 7 schematically shows support energy supplied to the three phases during a time window for balancing the first phase. In FIG. 5, steps that are always performed in the node are shown with solid boxes, while steps that can be performed in the processing unit are shown in dashed boxes.

In this case the first power support handling unit 30 comprises the phase voltage obtaining block 47 and the node controller block 50. If no processing in the cloud is made, it also comprises the phase voltage analysing element 48A, the needed power determining element 48B and one or more of the other elements of the voltage support determining block 48. Also, in this case the power support coordinating block 49 and the machine learning related blocks may be omitted.

Moreover, if the cloud processing unit 34 is used, then this could perform all the operations of the voltage support determining block 48, which means that in this case this block can be omitted from the first power support handling unit 30 in its entirety.

The method may again be started by the phase voltage obtaining block 47 obtaining phase voltages of the power grid having been measured at at least one measurement point, step 60, which can be done in the same way as in the first embodiment. These measurements are then forwarded to the voltage support determining block 48, which as was stated earlier, may be provided in the first power support handling unit 30 or in the processing unit 34.

The voltage support determining block 48 thus receives the phase voltage measurements from the phase voltage obtaining block 47. It may optionally also receive a request for voltage support, step 61, where this request may be sent from a control system for the power grid, which control system may be a supervisory control and data acquisition (SCADA) system. The request may also comprise the reference voltage V_{Ref}. The request can be sent on demand, or in a scheduled pattern. It is additionally possible that the request specifies a time window in the future in which support is needed, such as on a following day or in parts of a following day.

When support is needed, which may be immediately or in the future, such as in the time window specified in the request, the phase voltage analysing element 48A analyses each of the phase voltages. FIG. 6 shows the voltages of the first, second and third phases A, B, C during a time window of 24 hours for which power support has been requested. The voltages may need to have a nominal voltage level, such as 230 VAC.

The phase voltage analysis may comprise the phase voltage analysing element 48A analysing each of the phase voltages with regard to meeting the reference voltage V_{Ref}, step 62. This may involve performing a comparison of each of the phase voltages with a voltage threshold V_{T}, where if the voltage falls below or rises above the reference voltage V_{Ref}, and reaches the voltage threshold V_{T}, the corresponding phase is deemed to need support. As an example, for a nominal level of 230 VAC, the threshold may according to the example in FIG. 6 be set to 222 VAC. It can also be seen that in this example only the phase voltage of the first phase A is shown as reaching this threshold V_{T}.

For each phase having a voltage that has reached the threshold V_{T}, the needed power determining element 48B then determines power that the power grid needs assistance with for meeting the corresponding desired phase voltage V_{Ref}, step 63. This may be based on a difference in voltage between the reference voltage V_{Ref} and the measured voltage as well as on the measured or estimated current. The needed power may more particularly be the product of the current and the voltage difference.

The time length determining element 48C may in turn determine a length of time during which the power grid needs assistance with the needed power, step 64, which may be as long as the voltage remains below or above the reference level or the threshold level in the time window specified for the support.

The length of time during which the grid requires assistance with the needed power then makes up energy that is needed in the support. Needed energy may thus be calculated based on the determination of the length of time during which the power grid needs assistance with the needed power. The needed energy may be expressed as a number of blocks, each having a common length corresponding to a unit of time, such as one hour, and varying height corresponding varying power of the blocks. The needed energy is then the difference in energy between operation at the reference voltage and at the actual measured AC voltage, which is the power amount times the time unit. In FIG. 6, the difference in energy between operation at the reference voltage V_{Ref} and the threshold voltage V_{T} during a time unit of one hour is provided as an example on how an energy block E_{Diff} of the needed energy may be provided. The needed energy may be determined as a supply or reception of a number of energy blocks corresponding to one or more hours. It should be realized that an hour is merely an example of a used unit of time. It is for instance possible with minutes instead.

The condition information investigating element 48D then optionally investigates condition information of the energy storage elements 16 and 18 of the first power support node 12, step 66, which may involve an investigation about available energy in the energy storage units, such as remaining charge of each energy storage element 16 and 18 in the first bank of energy storage elements 14, for instance as a percentage of the remaining battery capacity and/or as and actual remaining charge in kWh. This determination may involve determining an available amount of energy that can be used for the support corresponding to the whole or at least a part of the above-mentioned needed energy, where the available energy may be limited by minimum allowed remaining charge levels or maximum charge levels of the energy storage units, and which specific energy storage unit to use.

Based on this information the power support determining element 48D then determines support power during at least one support time interval for providing support energy to the phase, where the support energy corresponds to or makes up at least a part of the energy that the power grid needs assistance with, step 67. The support energy may correspond to a part of the needed energy if one or more of the energy storage units reach a minimum allowed remaining charge level or a maximum charge level. The energy being delivered may additionally be divided into different sized energy blocks with the common unit of time. Power support determining element 48D may additionally determine more than one time interval in which the support energy may be provided.

It can be seen that when there is a request for voltage support from the power grid, the controlling that is performed during at least one support time interval is triggered by the request.

In the example shown in FIG. 7 all the phases are being supported. It can be seen in FIG. 7 that the first phase A is supported with six differently sized energy blocks starting one hour into the time window, that the second phase B is supported with two differently sized energy blocks in the first two hours of the time window and then after a period of seven hours with no power support, with a further five differently sized energy blocks. Finally, the third phase C is supported with one energy block one hour into the time window and then after a period of twelve hours with no power support, with two further differently sized energy blocks. As was mentioned earlier, each energy block has a unit of time of one hour power.

It can thus be seen that power is supplied in the first phase A in a first time interval, in a second and third time interval in the second phase B and in a fourth and a fifth time interval in the third phase C, where the first time interval is six hours long, the second time interval is two hours long, the third time interval is five hours long, the fourth time interval is one hour long and the fifth time interval is two hours long

After having determined support power, time intervals and support energy, the node controller block 50 is then informed. The power support determining element 48E of the voltage support determining block 48 may thus send an instruction to the node controller block 50 to support one or more of the phase voltage, whereupon the node controller block 50 continues and supports at least one phase with support power during at least one support time interval for providing support energy at least partly making up at least a part of the energy that the power grid needs assistance with. The node controller block 50 thus controls, based on the investigation of the condition information of the energy storage units 16 and 18, the first power supply node 12 to provide support energy corresponding to or making up at least a part of the needed energy, step 68. It may in some cases control the first power supply node 12 to provide support energy corresponding to or making up all of the needed energy.

The instruction thus triggers the node controller block 50 of the first power support node 12 to support the phase voltages. Thereby the node controller block 50 controls the first power support node 12 to support at least one of the phase voltages of the power grid with regard to meeting a desired phase voltage level based on the condition information as well as based on the analyses performed by the voltage support determining block 48. The support may more particularly involve using at least one of the energy storage units 16 and 18 of the first bank of energy storage units 14.

The node controller block 50 may for instance control the converters of the distribution network interface to make one or more energy storage units 16 and 18 of the first bank of energy storage units 14 to supply energy blocks to the power distribution network during the selected time units. It may also control one or more of the power support units 22, 24 and 26 to supply support energy to the corresponding phase of the power grid during these selected time units. If for instance the first phase A was the only phase needing support, then the first power supply unit 22 may be controlled to provide all the support energy, i.e. provide support energy corresponding to or making up all of the needed energy. However if all phases need support, the first power supply unit 22 is controlled to support the first phase A, the second power supply unit 24 is controlled to support the second phase B and the third power supply into 26 is controlled to support the third phase C for instance in the way shown in the example in FIG. 7.

The limitations of the bank of energy storage units put limitations on the available support energy. It is therefore possible that the first power support node is unable to provide support energy making up all of the needed energy.

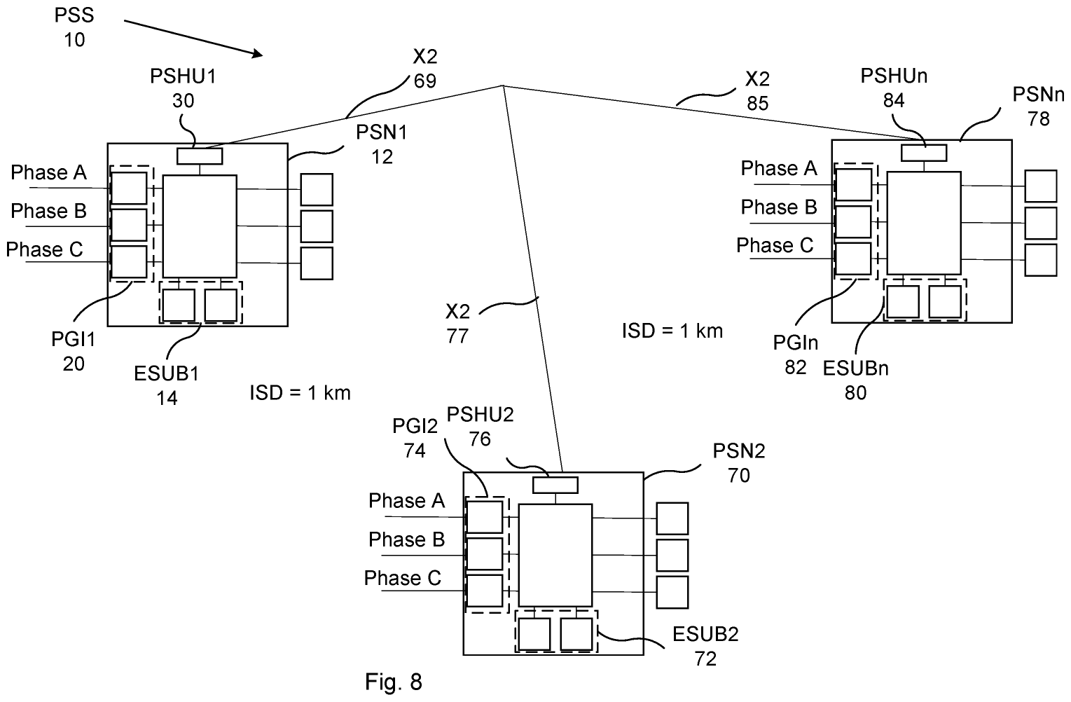

For this reason, the power supporting system 10 may comprise several power support nodes, which may additionally be located at a distance from each other. The power supporting system 10 may thereby comprise a group of power support nodes including the first power support node 12 which nodes are placed at different locations. One example of this is shown in FIG. 8, where there are n nodes. There is here the first power support node, 12 a second power support node PSN2 70 and an nth power support node PSNn 78, which are distanced from each other by an intersite distance, which as an example may be at least 1 km.

In the present example, the second and nth power support nodes 70 and 78 have the same realization as the first power support node 12. Thereby each power support node comprises an interface to the power grid with one connection per phase, a bank of energy storage units and a power support handling unit, where in relation the first power support node the power support handling unit of at least one other power support node supports at least one of the phase voltages of the power grid based on the analysis using at least one energy storage unit of the bank of energy storage units of this other power support node. Each power support node may additionally have at least one measurement point at the interface to the power grid. At such an interface there may more particularly be a measurement point at each of the connections to the power grid.

The second and nth power support nodes 70 and 78 thereby comprise a second power grid interface PGI2 74 and an nth power grid interface PGIn 82, each comprising one bidirectional power supply unit per phase for connection to the power grid, where in the present example each power grid interface 82 and 74 comprises three power supply units and each power supply unit has a grid side connected to a corresponding phase and a distribution network side connected to a power distribution network of the node. It can here be seen that as the nodes have the above-mentioned intersite distances between each other, the power grid interfaces 20, 74 and 82 are connected to different parts of the power grid, that are also separated from each other by distances corresponding to the intersite distance. The power grid interfaces 20, 74 and 82 also comprise sensors for measuring phase voltages and possibly also phase currents.

The second and nth power support nodes 70 and 78 also each comprise at least one load, where in the example in FIG. 8 each comprises three loads, which loads may also here be fed with power from the power grid via a local power distribution network. There is furthermore a second bank of energy storage units or first energy storage unit bank ESUB2 72 in the second node 70 and an nth bank of energy storage units ESUBn 80 in the nth node 78, where the banks of energy storage units 72 and 80 may also here comprise batteries, such as a Li-ion and VRLA batteries. It should also be realized that the energy storage units may be equipped with sensors, such as sensors for sensing battery charge level.

The second power support node 70 also comprises a second power support handling unit PSHU2 76 and the nth power support node 84 comprises an nth power support handling unit PSHUn 84, which power support handling units 76 and 84 each control support of the phase voltages of the power grid. For this they may be connected internally in their nodes in the same way as the first power support determining unit 30 in the first power support node 12.

Just as the first power support node 12, the second and nth power support nodes 70 and 78 may be access nodes of the previously mentioned mobile communication network. They may thereby also be base stations where their loads may because of this be realised as radio circuits and antennas for radio communication.

It is possible that also the second and nth the power support handling units 76 and 84 are connected to the previously mentioned processing unit 34 via a communication interface such as a backhaul communication interface or cloud interface (not shown). However, it is also possible that the processing is in its entirety performed in the power support handling units 30, 76 and 84, in which case these communication interfaces and the processing unit 34 may be omitted. Furthermore, as can be seen there are also signal connections between the power support nodes 12, 70 and 78. The first power support node 12 has a first signal connection 69, the second power support node 70 has a second signal connection 77 and the nth power support node has an nth signal connection 85, which signal connections 69, 77 and 85 in the example of a mobile communication network may be realized via a so-called X2 interface. In the example of FIG. 8, the first, second and nth signal connections 69, 77 and 85 are furthermore interconnected in a star-like fashion in order to allow each of them to communicate with each other.

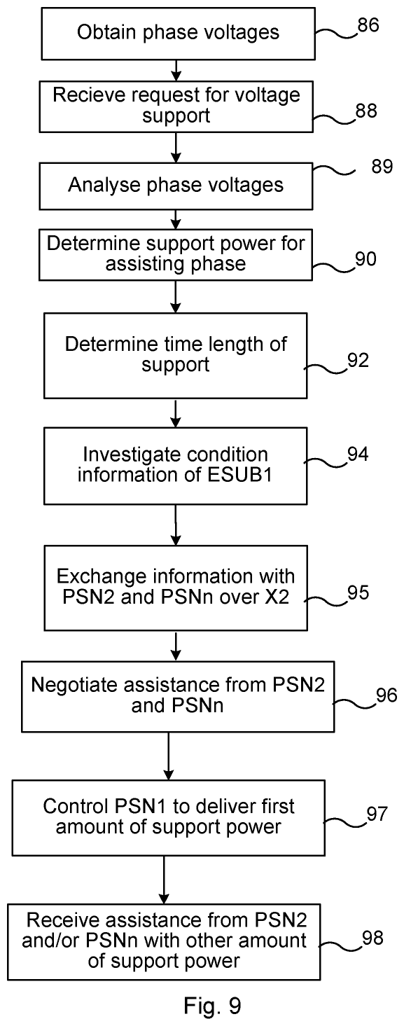

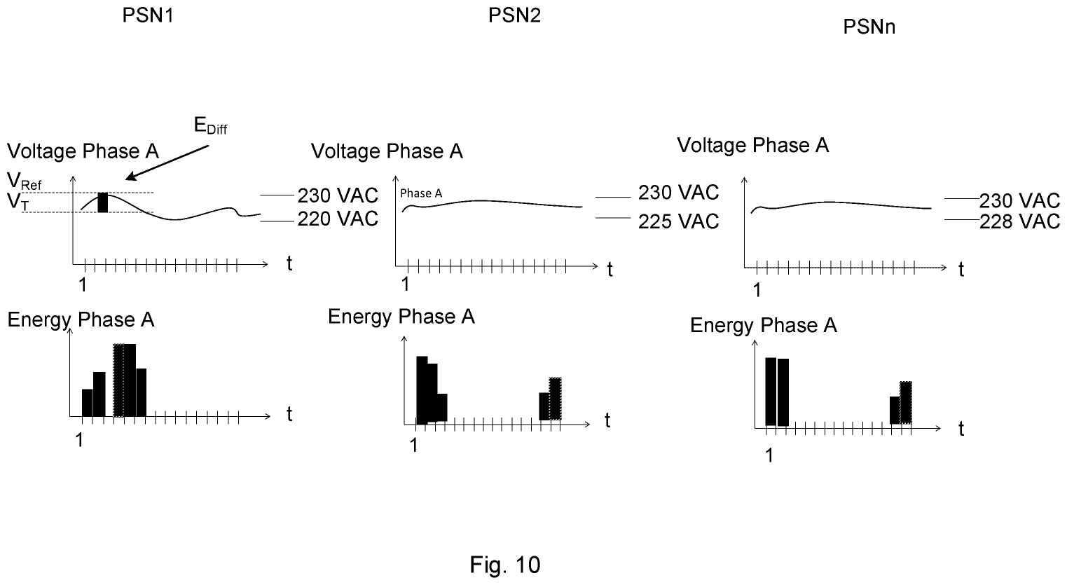

The operation in the first power support node 12 according to a third embodiment will now be described with reference also being made to FIGS. 9 and 10, where FIG. 9 shows a number of method steps in the method of supporting the electrical power grid and FIG. 10 shows voltages of a first phase at the different power support nodes, where a phase voltage of a first phase at the first power support node needs to be balanced, as well as support energy supplied to the first phase from the different power support nodes.

All phase voltages may be supported by all power support nodes. Alternatively, it is possible that a certain phase is supported by the first power support node and at least one other power support node.

The method may again be started by the phase voltage obtaining block 47 obtaining phase voltages of the power grid having been measured at at least one measurement point, step 86, which can be done in the same way as in the first embodiment at a point in the first power grid interface 20. These measurements are then forwarded to the voltage support determining block 48, which as was stated earlier, may be provided in the first power support handling unit 30 or in the processing unit 34. The same type of obtaining of phase voltages are being made in the second and nth power support node. However, in this case the measurement points are provided at the second and nth power grid interfaces 74 and 82.

The voltage support determining block 48 thus receives the phase voltage measurements from the phase voltage obtaining block 47. It may also receive a request for voltage support, step 88, where this request may again be a request sent from the control system for the power grid and may again comprise a reference voltage V_{Ref} as well as specify a time window in which support is needed, such as on a following day or in parts of a following a day.

When support is needed, which may be immediately or in the time specified in the request, the phase voltage analysing element 48A of the voltage support determining block 48 analyses each of the phase voltages with regard to meeting a desired voltage level such as the reference voltage V_{Ref}, where as an example it is again possible that the first phase A is found to need support because it reaches a threshold level V_{T}. This is exemplifier in the upper left graph in FIG. 10, which shows the voltage of the first phase A at the first power grid interface 20 during a time window of 24 hours for which power support has been requested and where the reference and threshold voltages V_{Ref} and V_{T} are again indicated.

The analysis of the phase voltage may again comprise the phase voltage analysing element 48A analysing each of the phase voltages with regard to meeting the reference voltage V_{Ref}, step 89. This may involve performing a comparison of each of the phase voltages with the voltage threshold V_{T}, where if the voltage falls below or exceeds the reference voltage V_{Ref}, and reaches the voltage threshold V_{T}, the corresponding phase is deemed to need support. As an example, for a reference level of 230 VAC, the threshold may according to the example in FIG. 10 be set to 222 VAC. It can be seen that in this example the phase voltage of the first phase A reaches the threshold V_{T}. The second and nth power support handling units 76 and 84 of the second and nth power support node 70 and 78 may analyse the voltages in the same way. As can be seen in the upper centre and right graphs of FIG. 10, it is possible that the voltage of the first phase A measured at these other nodes does not reach the threshold in the present example.

For each phase at the first power gird interface 20 that has reached the threshold V_{T}, the needed power determining element 48B of the first power support handling unit 30 then determines power that the power grid needs assistance with for meeting the reference voltage V_{Ref}, step 90. This may again be based on a difference in voltage between the reference voltage V_{Ref} and the measured phase voltage as well as on the measured or estimated phase current.

The time length determining element 48C may also determine a length of time during which the power grid needs support with the determined needed power, step 92, which may be as long as the voltage remains below the reference level or the threshold level in the time window specified for the support.

It is also here possible that the needed energy is determined, which may again be determined based on the power that is needed during the determined length of time, where the energy may be divided into energy blocks with a common time unit. The energy of an energy block may be the difference in energy between operation at the reference voltage V_{Ref}, and the measured voltage. In the upper left chart of FIG. 10, the difference in energy E_{Diff} between operation at the reference voltage and the threshold voltage for a time unit of one hour is again provided as an example on how the needed energy may be calculated.

The condition information investigating element 48D of the first power support handling unit 30 then investigates condition information of the energy storage elements in the first bank of energy storage elements 14, step 94, which may involve an investigation of the remaining charge of each energy storage elements both regarding remaining amount of energy and remaining charge level. This determination may involve determining the available energy of the energy storage units of the first back of energy storage units that can be used for supporting phases. Also the second and nth power support handling units 76 and 84 may investigate the condition information of the second and nth banks of energy storage units 72 and 80 and determine the available energy in the energy storage units.

The power support coordinating block 49 of the first power support handling unit 30 furthermore exchanges information with the power support handling units of the other power support nodes via the X2 interface, step 95, which information or control signal between the nodes may comprise information about phase voltage levels, possible required energy for the support of the respective phases and the condition information regarding available energy in the energy storage units of the banks of energy storage units.

It may be that the support energy that is available in the first power support node 12 is insufficient, i.e. cannot meet the needed energy. Therefore, the power support coordinating block 49 of the first power support node 12 may negotiate, via the signal connections, assistance from the other power support nodes 70 and 78 in the support of the at least one phase, step 96. The power support coordinating block 49 may more particularly negotiate assistance concerning a phase that is to be supported from the first power support node 12 where the negotiating may involve negotiating support energy from the other nodes, which phase the support energy is concerned with as well as time interval in which the support is to be made. The negotiating may also involve negotiating a common start time in the time window for the support. In the negotiation the condition information of the other nodes is considered.

The power support determining element 48E of the first power support handling unit 30 then determines a first amount of support energy that itself is to use in in the support and at least one time interval in which the first amount is to be used for supporting the phase using the first bank of energy storage elements 14. The node controller block 50 then controls the first power support node 12 to deliver the first amount of support energy in the determined time intervals, step 97. It also receives assistance from the one or more of the other power support nodes 70 and 78 with another amount of support energy in at least one other time interval, step 98, where the totality of the support energy provided by the power support nodes may make up the energy needed by the power gird for stabilizing the phase voltage. As the energy is formed through the provision of power in a corresponding time interval, it can be seen that the first power support handling unit controls the first power support node to support a phase voltage with a first amount of support power and the power support handling unit of the other power support node supports support the phase voltage of the power grid with another amount of support power.

In the example shown in the lower graphs in FIG. 10, the first power support node 12 has negotiated assistance from the second and the nth node 70 and 78 where the first node 12 supports the first phase A with two energy blocks starting one hour into the time window. This is followed by an hour with no support. Then support is again made using three energy blocks. The second power support node 70 supports the first phase A with three energy blocks starting one hour into the time window. Then after a period of eleven hours with no support, support is again made using two energy blocks. Finally, support is shown as being made to the first phase A from the nth power support node 78 using two energy blocks starting one hour into the time window, then after a period of eleven hours with no support, support is again made using two energy blocks. The first power support node 12 thus supports the first phase A in a first and a second time interval, the second power support node 70 supports the first phase in a third and a fourth time interval and the third power support node 78 supports the first phase A in a fifth and a sixth time interval, where the first time interval is two hours long, the second time interval is four hours long, the third time interval is three hours long, the fourth time interval is two hours long, the fifth time interval is two hours long and the sixth time interval is also two hours long. Moreover, the first, third and fifth time intervals all start at the same time, one hour into the time window. It can thereby be seen that the start of support is made at the same time in the nodes. The start of the support is thus synchronized.

It can in this way be seen that the different nodes can assist each other in the support of a phase. It is thereby possible to efficiently support a phase even if the available energy of the power support node where the phase voltage balancing is need is insufficient. The efficiency of the support is further enhanced by the synchronization.

In the third embodiment the power support coordinating block 48 is provided in the first power support handling unit 12, while the voltage support determining block 48 may be provided partly or wholly either in the processing unit or in the power support handling unit.

The power supporting system can be further varied. It is possible that there is central power support distribution control unit. It is possible that the first power supply node comprises this central power support distribution control unit. As an alternative if the power support nodes are access node of a mobile communication network, the central power support distribution control unit may be provided in an evolved packet core network (EPC) or a network management system such as OSS. The power support distribution control unit may thus be a part of the first power support node or be related to it, such as being provided in another node in the power supporting system. The power support distribution control unit may additionally be provided in the cloud.

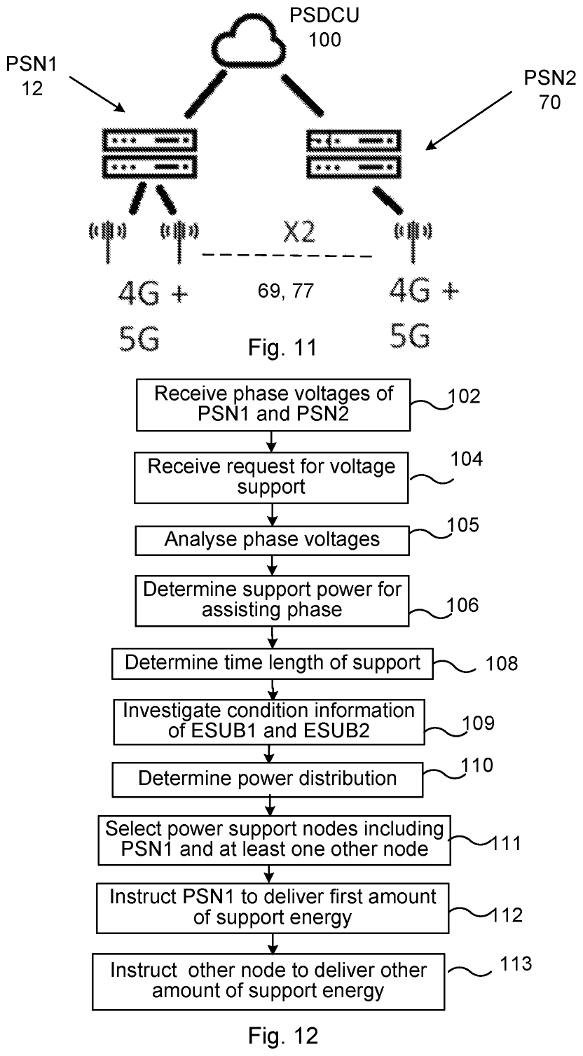

How the power support may be performed in a fourth embodiment using such a central power support distribution control unit, will now be described with reference being made to FIGS. 11 and 12, where FIG. 11 shows a third realization of the power supporting system comprising the first and a second power support nodes 12 and 70 communicating with the central power support distribution control unit PSDCU 100 and FIG. 12 schematically shows a number of method steps being performed by the power support distribution control unit 100.

For the sake of simplicity there are only two power support nodes in the power supporting system, which are the first and the second power support nodes 12 and 70. These communicate with the power support distribution control unit 100, for instance via the previously mentioned backhaul network interfaces and possibly also with each other via the connections 69 and 77 operating as X2 interface.

In this embodiment each of the power support handling units 30 and 76 of the nodes obtains the phase voltages measured at the corresponding power grid interfaces of the nodes and then forwards these voltages to the power support distribution control unit 100.

The power support distribution control unit 100 thus receives the phase voltages of the first and second power support nodes 12 and 70, step 102, where the phase voltages are phase voltages of the power grid having been measured at at least a first and a second measurement point at the power grid interfaces of the power support nodes, where the first measurement point may be provided at the first power grid interface 20 and the second measurement point may be provided at the second power grid interface 74.

The power support distribution control unit 100 may optionally also receive a request for voltage support, step 104, where this request may again be a request sent from the control system for the power grid and may voltage reference V_{Ref}, information about from which power support node support is needed as well as a time window in which support is needed.

The power support distribution control unit 100 implements the functionality of the voltage support determining block. Therefore, when support is needed, which may be immediately or in the time window specified in the request, the power support distribution control unit 100 may analyse each of the phase voltages at each of the power support nodes with regard to meeting the reference voltage, step 105. This may again involve performing a comparison of each of the phase voltages at the different nodes with the voltage threshold V_{T}. For a node deemed to need support the power support distribution control unit 100 then determines the power needed to support the phase, step 106, which may be done in any of the previously described ways. It may also determine the time length of the support, step 108, and thereby obtain information about the energy needed for the support. It may additionally investigate the condition information of the banks of energy storage units of all the power support nodes, step 109, where for this reason the power support coordinating blocks 48 of these nodes may forward the condition information concerning their energy storage units.

The power support distribution control unit 100 then determines the distribution of the power support between the nodes, step 110, which distribution may be based on the needed energy as well as available energy of the energy storage units. Thereby the decision is also based on the determined power as well as on the investigation of condition information of the energy storage units of each of the power support nodes. The power support distribution control unit 100 may also select power support nodes for supporting the phase voltage based on the determined needed power as well as based on the investigated condition information of the energy storage units of each of the power support nodes. In this case it is furthermore possible that the selection of power support nodes is based on the distances between the power support nodes and the shape of the phase voltages at their interfaces to the power grid. The selecting may additionally involve selecting the first power support node 12 and at least one other node, step 111. It may for instance select a power support node that is close to the power gird interface where support is needed. It may also select a node with the least disturbance on the phase voltage. Thereafter the power support distribution control unit 100 instructs the first power support handling unit 30 of the first power support node 12 to deliver a first amount of the support energy in at least one first time interval, step 112, as well as instructs at least one other node to deliver another amount of support energy in at least one other time interval, step 113.

The node controller blocks of the first and second power support handling units 30 and 76 then control their respective nodes 12 and 70 to provide power support in the associated time intervals. Thereby the first support handling unit controls the first power support node to support the at least one of the phase voltages of the power grid and the power support handling unit of the other power support node controls the other power support node to support the at least one of the phase voltages of the power grid based on the power support distribution determination made by the power distribution control unit 100, The control may additionally be based on a selection of power support nodes that has been made by the power support distribution control unit based on the determined needed power as well as based on investigated condition information of the energy storage units of each of the power support nodes.

It is also here possible that the support energy of all the used nodes make up all the energy needed for stabilizing the phase voltage. It is also here possible that the support is synchronized.

It should furthermore be realized that it is possible that the power support nodes locally analyse the phase voltages, determine support energy as well as investigates the condition information and inform the power support distribution control unit, which then makes a decision centrally about which node is to support which phase during which length of time.

It is additionally possible that the support that is given to the power grid is selected based on machine learning.

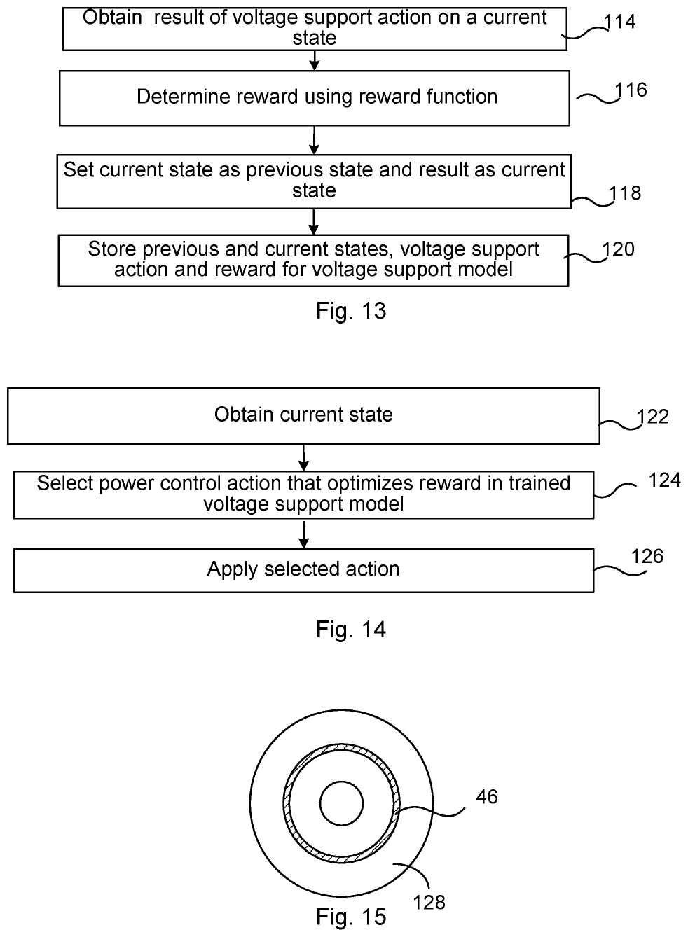

How this may be done for the case when the power support system 10 only comprises the first power support node 12, will now be described with reference being made to FIGS. 13 and 14, where FIG. 13 shows a number of machine learning method steps used in a voltage support model and being performed by the reward determining block 51 and the state space populating block 52 and FIG. 14 shows a number of method steps for supporting the electric power grid based on the voltage support model and being performed by the control action selection block 54.

A voltage support model may be implemented in the processing unit which, as was described earlier may be implemented in the cloud. The first power support handling unit 30 of the first power support node 12 may communicate with this model using the state space populating block 52, the training block 53 and the control action selection block 54. It should also be realized that some or all of the operations of these blocks may be performed in the previously described process unit or power support distribution control unit instead.

The phase voltages and condition information of the energy storage elements may be part of a state in a state space of the voltage support model, while the support power or support energy used in the power support may be a part of a power support action in an action space of the voltage support model. It is here possible that the action space also comprises then time window in which the action should be applied.

Moreover, the results of the power support actions comprise the change in phase voltage caused by the power support action and the change in condition of the energy storage units, e.g. the change in battery capacity. The results of the power support actions are thus states in the state space of the voltage support model. Thereby a current state on which a current power support action is to be used is the result of a previous power support action.

In order to be able to select actions, rewards are being calculated. For this reason, the reward determining block 51 is used.

The reward determining block 51 may operate based on a current state and a current power support action, where the current state comprises current phase voltages obtained from the phase voltage obtaining block 47 and current energy storage element conditions obtained from the condition information investigating element 48D, while the current power support action is the power support action being performed for addressing voltage imbalances in the current state. The current power support action may in this case have been selected according to a section policy, which selection may have been made by the control action selecting block 54. The power support determining element 48E may provide data about the current power support action.

The reward determining block 51 obtains data about the results of the current power support action on the current state, step 114. It thus obtains new energy storage condition data and new phase voltage data that include possible changes compared with the current state on which the current power support action operated. Thereafter the reward determining block 51 uses this data to determine or calculate a reward for the use of the current action using a reward function, step 116. Thereby it calculates a reward for a current power support action based on the result of the power support action. The reward function may have weights, and these weights may be pretrained. How a reward may be calculated will be described later.

The state space populating block 52 stores the power support actions and results of power support actions together with rewards in an experience memory.

In order to do this, it receives the reward as well as the results of the current power support action from the reward determining block 51. The state space populating block 52 also obtains the current state, i.e. the state on which the current power support action was used, as well as the current power support action. The state space populating block then sets the current state as a previous state, and the result of the current power support action as a new current state, step 118. Thereafter the state space populating block 52 stores the previous and current states, the current power support action and reward as an experience in an experience memory, step 120. Thereafter it may set the current power support action to be a previous power support action.

This above-described operation is then repeated and it can thereby be seen that a number experiences are stored in the experience memory.

In this way the state space populating block stores experiences in the experience memory, each comprising a previous and a current state, a power support action made on the previous state and a reward.

The state space populating block 52 thereby stores the condition information obtained by the condition information investigating element 48D and the phase voltages obtained by the phase voltage obtaining block 47 for populating the state space. The state space populating block also stores the support power used in the control by the node controller block 50 as well as perhaps the time of use of the support power to the model for populating the action space.

In the example given above, the operations were performed in the first power support handling unit. Alternatively, the calculation of a reward and the forming of episodes may be performed in the processing unit or power support distribution control unit, which may both be provided in the cloud.

The model may furthermore be trained by the training block 53, where the training may involve training the model for optimizing the reward.

After the model has been trained, the control action selection block 54 obtains the current state, step 122, and selects a power support action from the trained voltage supporting model that optimizes the reward, step 124. It then supplies the selected action to the node controller block 50, which goes on and applies it in the control of the node to support the one or more phase voltages, step 126. It can thereby be seen that the node controller block 50 controls the first power support node 12, after the power supporting model has been trained, using support power that is part of an action in the action space of the model that optimizes the reward.

It is also here possible that the control action selection block 54 and training block 53 are implemented in the processing unit or in the power support distribution control unit, which may both be cloud implemented.

The above-described scheme can also be extended for application on the other nodes.

The use of machine learning can according to a more detailed example be carried out in the following way.

One machine learning approach is to use single-agent reinforcement learning (RL). In RL, there exist two basic constituents, an agent and an environment. Given a state of the environment, an agent takes an action according to a policy that it maintains internally. The effectiveness of the action is interpreted by the environment into a reward, which it communicates, together with the new state of the environment back to the agent. The goal of the agent is to learn the optimal policy for every state of the environment, meaning the choice of action that would yield the largest immediate and long-term reward.

The reason for using RL for this scenario, is because of the different behaviour of the power grid observed in different geographical areas. In the present example it is not known in advance what the patterns of behaviour of the power grid may look like in different areas (i.e. in terms of voltage fluctuations), so RL is used to learn those patterns of behaviour over time.

In the present RL approach, the reward determining block, state space populating block, training block and control action selection block may together form such an agent managing one power support node. These blocks may also be provided in the central power support distribution control unit in order to manage a neighbourhood of power support nodes in what is considered a single-agent reinforcement learning problem.

Over time, and by observing power-related measurements in a power support node or group of power support nodes, the agent learns about the voltage fluctuations caused by the power grid on any of the—phases for the power support node or power support nodes being managed.

In order for this idea to work, it may be assumed that every power support node is equipped with a bank of energy storage units (batteries), as well as bi-directional PSUs (i.e., PSUs that not only draw power from the grid but also feed power back to the grid). In order to use RL to solve the problem, it can first be formalized as a Markov Decision Process (MDP) with unknown transition probabilities, therefore comprising a state space, a reward and an action space.

The state space may comprise the following observations-per power support node: current battery reserves and battery capacity (in terms of % of total capacity and Ampere hour—Ah—respectively), observed voltage on phase A, B, C for each node in volts. In addition, state information contains the price of energy sale provided from the power grid to the power support node but also from the power support node to the grid. This price can be expressed for example in terms of cost per watt-hour and can be a single number in case the charging is universal or can differ in time (for example different price during peak-hours and/or night-time). The last piece of information is a timestamp indicating the time of observation.

The above information is aggregated into a series of observations, serialized into a state description which is received by the agent as a result of its action. An example of such a serialization is the following:
[32%, 1200, 220V, 221V, 219V, 12, 55, 2021 Dec. 12 11:11], [31%, 1200, 210V, 221V, 219V, 12, 55, 2021 Dec. 12 11:12], [30%, 1200, 200V, 221V, 219V, 12, 55, 2021 Dec. 12 11:13], [29%, 1200, 210V, 221V, 219V, 12, 55, 2021 Dec. 12 11:14], [28%, 1200, 220V, 221V, 219V, 12, 55, 2021 Dec. 12 11:15]

In the above given example, power grid sells to power support node at the cost of e.g., 12 Swedish Crowns (SEK) per Watt-hour (kWh), and vice-versa for 55 SEK per kWh.

In this case, the state may be reported as a series of timestamped data, that reveals power fluctuations at the first phase A of the power grid (and potential action would be to direct power to the first phase A from the power support node).

When the single-agent case is considered then the agent has full observability over the state space, meaning all the aforementioned information are available to it.

The action space comprises an instruction to transfer current from one or more PSUs of a power support node to the power grid, thus discharging the battery, parameterized also by the phase that each PSU should transfer current for (i.e., A, B, C). The instruction can also be reversed, i.e., to transfer power from the grid to the power support node, charging its batteries. The support power can be expressed in watt-hours or kWh or a precedent or antecedent. Therefore, the size of the action space for every power support node is dependent on the number of PSUs in the power support node. Action also includes a window of opportunity, i.e., a time when the action is supposed to take place. Depending on the implementation window of opportunity can also be a time duration, i.e., between two points in time when the power is fed back to the grid. Formally, the action space is defined as follows:
A=[a1, . . . , aX]: am=[[phase, direction, power_amount, window_of_opportunity, suggested_price], . . . ]∀am∃A

For example:
[B,0,20,2021-12:12 12:00-2021-12-12 13:00,55]

This action indicates that for phase B and direction o (i.e., from power support node to grid), 20 w of power should be transferred between 12:00 to 13:00 on Dec. 12, 2021 for 55 SEK/kWh. Actions may contain more than one phase, but for reasons of simplicity, every action is here limited to a specific time window and not multiple windows.

The reward function, as a result of the action of the agent(s) is based on two constituents. First, the achieved voltage level and voltage volatility (fluctuations) and second the price of sale of the energy. The actual formula could be a weighed sum between the voltage improvements and monetary gains. For example, considering
the voltage level to be a ratio of achieved voltage V to desired voltage V_{Ref},
the fluctuations of the voltage to be a ratio of a standard deviation of reference voltage values σ_{ref} to a standard deviation of achieved voltage values σ_{achieved}, and
assuming a sale from power support node to the power grid, the monetary gains to be a ratio of achieved value of sale sale_{ach} of e.g., kilowatt-hour (Kwh) to reference value of sale sale_{ref}

Then reward r could be calculated as follows:

$$R = \frac{{w}_{voltage} \cdot ( \frac{\frac{{v}_{achieved}}{{v}_{ref}} + \frac{{σ}_{achieved}}{{σ}_{ref}}}{2} ) + {w}_{cost} \cdot ( \frac{{sale}_{ach}}{{sale}_{ref}} )}{2}$$

On the other hand, assuming a sale from the power grid to the power support node, the monetary gains are the inverse ratio (as it is in the interest of the operator to achieve the lowest cost of purchase:

$$R = \frac{{w}_{voltage} \cdot ( \frac{\frac{{v}_{achieved}}{{v}_{ref}} + \frac{{σ}_{achieved}}{{σ}_{ref}}}{2} ) + {w}_{cost} \cdot ( \frac{{sale}_{ref}}{{sale}_{ach}} )}{2}$$

In this case, the voltages and fluctuations are monitored on the power support node side.

The weights w_{voltage} and w_{cost} can be adjusted by the operator (or the owner of the application) to bias the chosen actions of the agent towards greater improvement of the power grid or monetary gains. The sum of these weights is always 1:

w_{voltage}+w_{cost}=1

A reward closer to 1 would indicate that the agent has become experienced in choosing optimal actions for a state (i.e., in RL terms, the agent would approximate the optimal policy). In case the agent is managing multiple power support nodes, then the above values can be averaged for all power support nodes managed by the agent.

If considering an implementation using a Double Deep Recurrent-Q Network (DRQN). The agent may use two neural networks, a DRQN which is trainable, and a Target Q-Network (TQN) which is not trainable but is used to stabilize training of the former. The agent also has an internal “experience” buffer, which stores experiences during training process. An experience is a 4-tuple of current state, action, reward and new state returned by the environment (in our case the power support node or plurality of power support nodes). This experience buffer can be a cyclic buffer meaning that older experiences are replaced by newer ones. The agent initializes the training process by randomizing the weights of DRQN, TQN and initializing the experience buffer.

Subsequently, the training process starts in iterations known as “episodes”. In every episode, the agent observes the current state from the environment (i.e., the plurality of power support nodes) and selects an action based on a selection policy. An example of such a selection policy is the e-greedy (epsilon-greedy) policy, wherein an action is selected at random first, while the agent gathers enough experiences to train the DRQN, at which point the action is chosen based on DRQN output.

Eventually, the power support node returns the reward and the next state of the environment, and the agent stores the state, action, reward and new state as an experience into its experience buffer. Every X number of iterations, the power support node trains its DRQN using e.g., gradient descent. The TQN may be used as the ground truth in this training process—its weights copied from DRQN every M iterations, M being far greater than X.

During operation, the trained DRQN may be used to make predictions of when to switch power from the power support node to grid and/or vice versa, given the state of the power support node and the grid. The technical effect of the proposed algorithm therefore is the transfer of power from the power support node to the power grid, or vice versa during the window of opportunity provided as part of the action identified by the trained DRQN.

The previously described algorithm accounts for a single agent managing a single power support node. In a more collaborative scenario, there could be multiple power support nodes (e.g. 3) collaborating together to either provide power to the grid in order to stabilize voltage and/or set it to a desirable level. Alternatively, to retrieve power from the grid based on projected needs and pricing. In this case, there is still a single agent that is receiving state updates from and actuating PSUs of potentially all power support nodes that it is responsible for. If the power support node is a base station of a mobile communication network, the agent can be located in the Operations Support System (OSS) of the mobile operator, or it could be located in any of the power support nodes that it is managing. The extension of the state space includes a description of the origin/target power support node in every data point of the state description:
State=list_of [battery_reserve, total_capacity, A_observed_voltage, B_observed_voltage, C_observed_voltage, cost_of_sale_to_operator, cost_of_sale_to_grid, timestamp, origin_PSN]]
Action=list_of [phase, direction, power_amount, window_of_opportunity, suggested_price, target_PSN]]

This algorithm resembles the previous described algorithm, with the difference being that state description should include datapoints from all power support nodes and action can concern one or more power support nodes that the agent is managing. In the case of a mobile communication network, the origin and target power support node can be identified using a globally unique cell identifier (Cell-ID or CID).

One consideration for deployment of the solution is the requirement for training of the agent's deep neural network (DRQN). Training may take a significant amount of time, and thus increase lead-time of the solution. An idea to accelerate training is to use transfer learning. Instead of initializing the weights of the neural network to random numbers as described earlier, it is possible to use pre-trained weights from a DRQN trained with typical power grid patterns of voltage dips and pricing information. This “baseline” DRQN model could be trained in a lab, or on a small set of initial power support nodes. Using this default DRQN instead of random weights would in turn require smaller set of iterations during training. The reward function thus comprises weights that are pretrained.

Another way transfer learning can be used is during site commissioning (i.e., introduction of new power support nodes to the power supporting system). In this case, instead of using the default DRQN, the new power support node could observe over time the behavior of the power grid and profile it (e.g. map it to a probability distribution). Then it can compare the probability distribution with those of other power support nodes which already have trained DRQNs. This can be done either in a mesh-type of manner, using X2 protocol, or centralized using an Operation Support System (OSS). This alternative of transfer learning may require a critical mass of already trained DRQNs in different areas where power grid also exhibits different patterns of voltage fluctuations, so it can be used later in the lifetime of the solution.

The computer program instructions used for implementing the first power support handling unit may be provided as a computer program that implements the first power support handling unit when being run by the corresponding processor. As an alternative, the computer program may be included in a computer program product for instance as computer program code on a data carrier, such as a CD ROM disc or a memory stick. In this case the data carrier carries a computer program with the computer program code, which will implement the above-mentioned power support handling unit. One such data carrier 128 with the computer program code 46 is schematically shown in FIG. 15.

In the power support handling unit
the phase voltage obtaining block may be considered to comprise means for obtaining phase voltages of the power grid, which phase voltages have been measured at at least one measurement point,
the voltage support determining block may be considered to comprise means for determining voltage support, where
   the phase voltage analysing element may be considered to form means for analysing each of the phase voltages with regard to meeting a desired phase voltage level,
   the needed power determining element may be considered to form means for determining the power with which the power grid needs assistance,
   the time length determining element may be considered to form means for determining the length of time during which the power grid needs assistance,
   the condition information investigating element may be considered to form means for investigating the condition information of the energy storage units, and
   the power support determining element may be considered to form means for determining support power during at least one support time interval for providing support energy to the phase,
the power support coordinating block may be considered to form means for exchanging information with the power support handling units of the other power support nodes and means for negotiating assistance in the support of the at least one phase,
the node controller block may be considered to comprise means for controlling the first power support node to support at least one of the phase voltages of the power grid based on an analysis of each of the phase voltages, where the analysis of a phase voltage is an analysis concerning meeting a desired phase voltage level and the support involves using at least one energy storage unit of the first bank of energy storage units,
the reward determining block may be considered to form means for calculating a reward for a current power support action based on the result of the power support action,
the state space populating block may be considered to form means for storing power support actions, the result of the power support actions and rewards,
the training block may be considered to form means for training the voltage support mode, and
the control action selection block may additionally be considered to form means for selecting an action in the action space.

The power support distribution control unit may additionally be considered to form means for performing a power distribution determination and to comprise means for selecting power support nodes for supporting the phase voltage based on a determined needed power as well as based on investigated condition information of the energy storage units of each of the power support nodes.

While aspects of the present disclosure have been described in connection with what is presently considered to be most practical and preferred embodiments, it is to be understood that the disclosure is not to be limited to the disclosed embodiments, but on the contrary, is intended to cover various modifications and equivalent arrangements. Therefore, the disclosure is only to be limited by the following claims.

1. A power supporting system for an electrical power grid, the power supporting system comprising a first power support handling unit and a first power support node, the first power support node comprising a first bank of energy storage units and a first interface to the power grid with one separate connection per phase, the first power support handling unit comprising a processor acting on computer instructions whereby the first power support handling unit is operative to:
obtain phase voltages of the power grid having been measured at least one measurement point; and
control the first power support node to support at least one of the phase voltages of the power grid based on an analysis of each of the phase voltages with regard to meeting a desired phase voltage level, which support involves using at least one energy storage unit of the first bank of energy storage units.

2. The power supporting system according to claim 1, wherein the first power support handling unit is operative to perform the control also based on a request for voltage support from the power grid.

3. The power supporting system according to claim 1, wherein the first power support handling unit is further operative to, when being operative to control the first power support node to support at least one of the phase voltages, control the first power support node to support the at least one of the phase voltages of the power grid with support power corresponding to at least a part of the power that the power grid needs assistance with for meeting the corresponding desired phase voltage level.

4. The power supporting system according to claim 3, wherein the first power support handling unit when being operative to control the first power support node to support at least one of the phase voltages, is operative to control the first power support node to support the at least one of the phase voltages of the power grid with support power during a support time interval for providing support energy at least partly making up energy (EDiff) that the power grid needs assistance with, which needed energy (EDiff) is based on a determination of a length of time during which the power grid needs assistance with the needed power.

5. The power supporting system according to claim 4, wherein the first power support handling unit is operative to control the first power support node to support the at least one of the phase voltages of the power grid with support power during more than one time interval.

6. The power supporting system according to claim 1, wherein the first power support handling unit is further operative to control the first power support node to support at least one of the phase voltages of the power grid also based on an investigation of condition information of the energy storage units of the first power support node.

7. The power supporting system according to claim 6, wherein the condition information comprises information about available energy in the energy storage units.

8. The power supporting system according to claim 6, wherein the phase voltages and condition information are part of a state in a state space and the support power is a part of a power support action in an action space of a voltage supporting model, wherein in the model power support actions and results of power support actions are stored together with rewards for the power support actions calculated using a reward function, where according to the model a current state on which a current power support action is to be used is the result of a previous power support action and the first power support handling unit when being operative to control the first power support node is further operative to control the first power support node, after the power supporting model has been trained, using support power that is part of an action in the action space of the model that optimizes the reward.

9. The power supporting system according to claim 8, wherein the reward function comprises weights that are pretrained.

10. The power supporting system according to claim 1, further comprising a group of power support nodes at different locations, the group including the first power support node, each power support node comprising an interface to the power grid with one connection per phase, a bank of energy storage units and a power support handling unit, where the power support handling unit of at least one of the other power support nodes is operative to support the at least one of the phase voltages of the power grid using at least one energy storage unit of the bank of energy storage units of this other power support node based on the analysis.

11. The power supporting system according to claim 10, wherein the first power support handling unit, when being operative to control the first power support node to support a phase voltage of the power grid, is operative to control the first power support node with a first amount of support power and the power support handling unit of the other power support node being operative to support the phase voltage of the power grid with another amount of support power.

12. The power supporting system according to claim 10, further comprising signal connections between the power support nodes and wherein the first power support handling unit is operative to exchange information with the power support handling units of the other power support nodes concerning obtained phase voltages and condition information of energy storage units as well as to negotiate assistance in the support of the at least one phase via the signal connections.

13. The power supporting system according to claim 10, wherein the analysis of each of the phase voltages with regard to meeting a desired phase voltage level and an investigation of condition information of energy storage units are performed in a power support distribution control unit, where additionally the investigation of condition information is an investigation of condition information of the energy storage units of all the power support nodes, wherein the first power support handling unit is operative to control the first power support node to support the at least one of the phase voltages of the power grid and the power support handling unit of the at least one other power support node is operative to control the at least one other power support node to support the at least one of the phase voltages of the power grid based on a power support distribution determination made by the power distribution control unit.

14. The power supporting system according to claim 13, wherein the first power support handling unit is operative to control the first power support node to support the at least one of the phase voltages of the power grid and the power support handling unit of the at least one other power support node is operative to control the at least one other power support node to support the at least one of the phase voltages of the power grid based on a selection of power support nodes for supporting the phase voltage that has been made by the power support distribution control unit based on a determined needed power as well as based on investigated condition information of the energy storage units of each of the power support nodes.

15. The power supporting system according to claim 13, further comprising the power support distribution control unit.

16. The power supporting system according to claim 1, wherein the interface of each power support node comprises at least one power supply unit for supporting the phase voltages.

17. A method of supporting an electrical power grid, the method being at least partly performed by a first power support handling unit of a power supporting system that comprises a first power support node having a first bank of energy storage units and a first interface to the power grid with one separate connection per phase, the method comprising:
obtaining phase voltages of the power grid having been measured at least one measurement point; and
controlling the first power support node to support at least one of the phase voltages of the power grid based on an analysis of each of the phase voltages with regard to meeting a desired phase voltage level, which support involves using at least one energy storage unit of the first bank of energy storage units.

18. The method according to claim 17, wherein the supporting is also based on a request for voltage support from the power grid.

19. The method according to claim 18, wherein the request comprises the desired phase voltage level.

20-31. (canceled)

32. A computer storage medium storing a computer program for supporting an electrical power grid from a power supporting system that comprises a first power support node having a first bank of energy storage units and a first interface to the power grid with one separate connection per phase, the computer program comprising computer program code which when run by a processor of a first power support handling unit of the power supporting system, causes the first power support handling unit to:
obtain phase voltages of the power grid having been measured at least one measurement point; and
control the first power support node to support at least one of the phase voltages of the power grid based on an analysis of each of the phase voltages with regard to meeting a desired phase voltage level, which support involves using at least one energy storage unit of the first bank of energy storage units.

33. (canceled)
